(19) United States
(12) Patent Application Publication
(10) Pub. No.: US 2015/0321211 A1
(43) Pub. Date: Nov. 12, 2015

(54) COMPOSITE TAPE

(71) Applicant: Seok-joo KIM, Seoul (KR)

(72) Inventor: Seok-Joo KIM, Seoul (KR)

(21) Appl. No.: 14/655,429

(22) PCT Filed: Dec. 28, 2013
(86) PCT No.: PCT/KR2013/012282

§ 371 Date: Jun. 25, 2015

(30) Foreign Application Priority Data
Dec. 28, 2012 (KR) 10-2012-0156740

(51) Int. Cl. B05B 15/04; B32B 27/10

(52) U.S. Cl. CPC B05B 15/0456; B32B 27/10

(57) ABSTRACT

The present invention relates to a composite tape for covering, during painting work, the areas not being painted so as to prevent sprays of paint spread from a gun from contaminating same. When the areas not being painted are covered by the composite tape, the lower edges of the composite tape can be taped without using a separate tape. To that end, the composite tape, which is wound around a paper tube with tape (12) overlappingly attached to the upper end of a covering member (11) and vinyl (13) overlappingly attached to the inner or the outer side thereof, is characterized by being wound around a paper tube with one edge of the vinyl (13) fixed to the bottom edge of the covering member (11).

### TECHNICAL FIELD

The present invention relates to a composite tape for covering the remaining portions except for a painting portion so as to prevent the remaining portions from being contaminated since a paint being separated from a gun sprays onto the remaining portions except for the painting portion which is intended to be painted during the painting work, and in particular to a composite tape which can resolve a problem that a covering member flaps, without taping a covering member, which is made of paper, in a state where the remaining portions are covered, except for a painting portion, using a composite tape.

### BACKGROUND ART

In general, a tape used to cover the near portions except for a painting portion during a vehicle painting work may be categorized into a masking paper tape, a vinyl covering tape, a composite tape, etc. The near portions except for a painting portion is masked using at least one tape among the above-listed tapes, and a painting work is performed, and after the painting work is finished, such a tape is removed from a vehicle body.

FIG. 1 is a view illustrating a state where a conventional composite tape is wound on a paper tube, and FIG. 2 is a vertical cross sectional view illustrating a state where a covering member and a vinyl are loosened from a paper tube, and FIG. 3 is a view illustrating a state where a conventional composite tape is used inverted. The conventional masking tape includes a tape 1 which is attached to a painted surface, a paper covering member 2 the top of which is fixedly adhered to the tape, a vinyl 4 which is overlapped inside the covering member, one end of the vinyl being adhered to the tape 1, and a paper tube 3 around which the covering member 2 wound in a state where the vinyl is overlapped.

In the conventional composite tape with the above-described configuration, the covering member 2 is unwound by the length of masking from the pipe tube 3, and the tape 1 is taped on a vehicle body, and the covering member 2 and the overlapped vinyl 4 are cut at a desired length, and the vinyl overlapped inside the covering member 2 flies is stretched out downward as illustrated in FIG. 2, and the lower side is attached using another tape 5, thus finishing the masking work.

The above-described conventional composite tape, however, has the following problems.

First, since a boundary portion between the covering member and the vinyl are separated, it needs to fixedly adhere the lower side of the covering member using a separate tap, which results in low work efficiency.

Second, if a painting work is performed in a state where the lower side of the covering member is not fixedly adhered, the covering member flaps by wind or a spraying pressure of the paint which is sprayed from a spray gun, which may result in low workability. The paint or dust or impurities which have been attached to the covering member during the painting work may separate from the covering member by wind occurring during the painting work which is performed using a spray un, and may attach to a painting surface which is not dried up or may fly into a gap of the covering member during the painting work, thus causing serious painting defects.

Third, as illustrated in FIG. 3, in case where the attachment of the composite tape is performed in the reverse direction, the covering member may separate from the vinyl due to its self-weight, so it inevitably needs to adhere an end of the covering member using a separate tape so as to finish the painting work.

### DISCLOSURE OF INVENTION

Accordingly, the present invention is made in an effort to resolve the above problems. It is an object of the present invention to provide a composite tape which is able to prevent any flapping which may occur since a covering member separates from a film, without using a separate tape in a state where a painted surface is masked.

It is another object of the present invention to provide a composite tape which makes it possible to cover wider areas using as much as the area of a vinyl same as the area in the conventional art.

To achieve the above objects, there is provided a composite tape, which may include, but is not limited to, a tape 12 which is attached to the top of a covering member 11; and a vinyl 13 which overlaps inside or outside the covering member and is wound around a paper tube, wherein an end portion of the vinyl 13 is fixed at a lower side of the covering member 11 and is wound around the paper tube.

### Advantageous Effects

As compared to the conventional composite tape, the present invention has the following advantages.

First, since the vinyl is fixed at the lower side of the covering member, the covering member and the vinyl can be integrated without using any tape. For this reason, the flapping of the covering member as in the conventional composite tape does not occur even when wind due to the use of the spay gun blows during the painting work, thus enhancing workability during the painting work, while preventing a phenomenon where the paint on the covering member separates and sticks onto a painting surface which is not dried yet.

Second, as illustrated in FIG. 3, even when the attachment of the composite tape is made in the reverse direction, the vinyl is fixed at the end of the covering member, so the covering member does not separate from the painted surface, thus obtaining the above-mentioned effects.

### BRIEF DESCRIPTION OF DRAWINGS

FIG. 1 is a view illustrating a state where a conventional composite tape is wound around a paper tube.

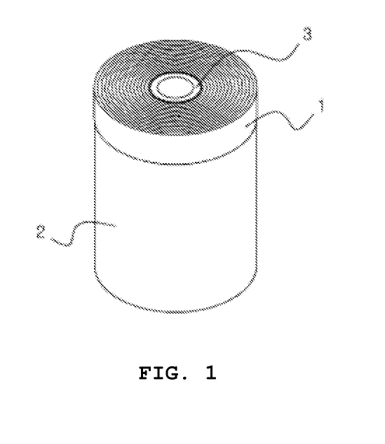

FIG. 2 is a vertical cross sectional view illustrating a state wherein a covering member and a vinyl are wound from a paper tube

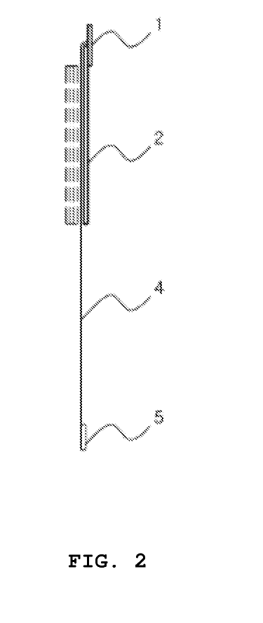

FIG. 3 is a view illustrating a state where a conventional composite tape is used inverted.

FIG. 4 is a vertical cross sectional view illustrating a composite tape according to a first exemplary embodiment of the present invention.

FIG. 5 is a vertical cross sectional view illustrating a composite tape according to a second exemplary embodiment of the present invention.

### BEST MODES FOR CARRYING OUT THE INVENTION

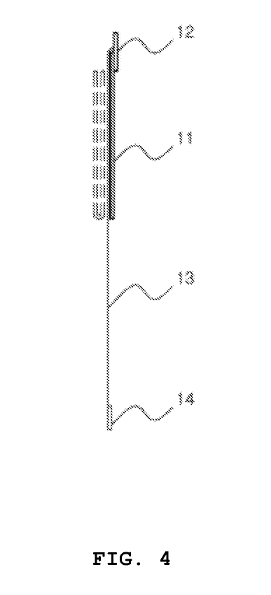

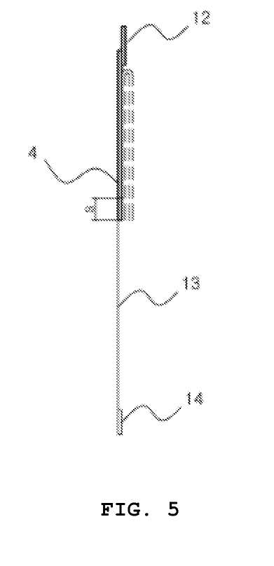

Hereinafter, the present invention will be described with reference to FIGS. 4 and 5.

FIG. 4 is a vertical cross sectional view illustrating a composite tape according to an exemplary embodiment of the present invention. A tape 12 is attached to the top of a covering member 11 made of a paper material and is wound around a paper tube (not illustrated) and at the lower side of the covering member 11, with an end portion of the vinyl 13, which is overlapped forming multiple steps, being fixed.

The vinyl 13 fixed at the lower side of the covering member 11 may be fixed at the inner side as illustrated in FIG. 4, but it should be understood that the vinyl 13 may be fixed at an outer side of the covering member 11 as illustrated in FIG. 5.

As illustrated in FIG. 4 according to an exemplary embodiment of the present invention, the vinyl 13 is fixed at an inner side of the covering member 11, thus preventing any decrease in the area of the covering member 11 made of a paper material, but as illustrated in FIG. 5 according to another exemplary embodiment of the present invention, the vinyl 13 is partially fixed at an outer side of the covering member 11, the area of the covering member 11 made of a paper material decreases. For this reason, the configuration in FIG. 4 is preferred.

The vinyl 14 one end of which is fixed at an inner side or an outer side of the covering member 11 according to the present invention may be fixed using an adhesive or may be fixed in various types. Such configurations are not limited thereto.

In addition, the adhering method of the vinyl fixed with the covering member may be implemented in various ways. If an adhering portion, however, gets thicker, the outer diameter of the adhered portion may increase when winding around the paper tube, the shape of the product may look distorted.

In order to improve the above phenomenon, it needs to minimize the thickness by coating thinly an adhesive onto the covering member or the vinyl, which makes it possible to obtain a composite tape the outer appearance of which is uniform.

Meanwhile, in case of a painting work in a common facility (inner and outer walls in an indoor space, facilities, etc.), any concern that paint might fly can be less, so it does not need to perform a corona process on the outer surface of the vinyl 13. However, in case of a painting work on a vehicle, there may be concern that paint stuck to the covering member 11 may fly by wind or a spraying pressure of a spray gun, so it is preferred to perform a corona process on the surface of the vinyl 14 which is exposed to the outside.

Even though micro dusts produced in the architectural field and stuck on the painting surface might not be a problem in the painting work, micro dusts during the painting of a vehicle may be a cause for painting defects even if such micro dusts are not visible. In this case, a serious problem may occur, for example, a painting work should be conducted again.

It is obvious that the corona-processed surface should be fixed at the covering member 11 while being exposed to the outside in a state that the vinyl 13 wound around the paper tube in an overlapping shape inside or outside the covering member 11 has stretched out.

Therefore, the tape 12 is taped on the painting surface while unwinding from the paper tube the covering member 11 as long as the length of the masking when masking the remaining portions except for the painting surface, and the covering member 1 and the overlapped vinyl 13 are cut at desired lengths.

The above-described procedures are same as the conventional procedures.

However, different from the conventional composite tape, when the vinyl 13 overlapped inside or outside the covering member 11 is pulled and stretched out, since an end portion of the vinyl 13 is fixed at the lower side of the covering member 11, the vinyl 13 does not flap on the covering member 11 unless a separate taping work is not performed.

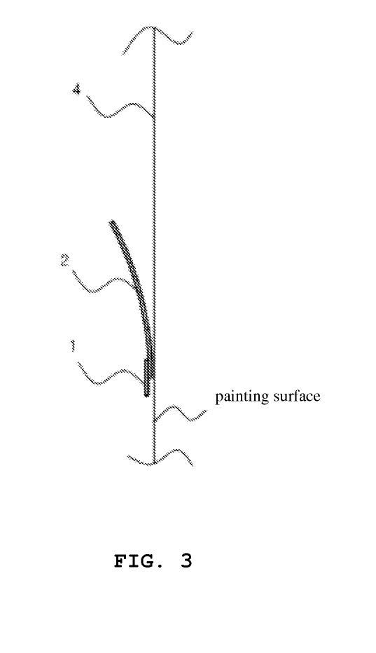

Meanwhile, as illustrated in FIG. 3, if the composite tape is installed reversed, since it is fixed at a boundary portion between the covering member 11 and the vinyl 13, it is possible to prevent the covering member 11 from separating from the vinyl 13.

Since the end of the vinyl 13, which has been stretched out from the covering member 1, is fixed at a portion of the vehicle body or a facility using another tape 14, it is possible to prevent paint from contaminating the remaining portions except for the painting portion during the painting work, and it is possible to prevent a phenomenon that the painting surface is contaminated by the spraying of the paint which sticks on the covering member.

### Modes for Carrying Out the Invention

The technical concepts of the present invention have been descried along with the above exemplary embodiments, but it is noted that such exemplary embodiments were described for illustrative purposes, not limiting.

In addition, it should be understood that a person having ordinary skill in the art can modify into various forms without departing from the scope of the resent invention.

Legend of Reference Numbers

| | |
|---|---|
| 11: Covering member | 12, 14: Tape |
| 13: Vinyl | |

### INDUSTRIAL APPLICABILITY

The applicable field of the present invention mainly is a partial painting or the whole painting of a vehicle and an architecture field and other analogous industrial sector.

In case of the vehicle painting, the conventional painting composite has a problem in that there is provided a vinyl itself, so paint may fly or may get on a vinyl and may roll down, thus contaminating the non-painting portions, and when the vinyl is removed, a newly applied paint may peel In the present invention, the vinyl and the member (for example, paper) are combined, so a clean work can be secured without causing any of the above-mentioned problems.

### LIST OF SEQUENCES

None

1. A composite tape, comprising:
a tape (12) which is attached to the top of a covering member (11); and
a vinyl (13) which overlaps inside or outside the covering member and is wound around a paper tube,
wherein an end portion of the vinyl (13) is fixed at a lower side of the covering member (11) and is wound around the paper tube.

2. The tape of claim 1, wherein the vinyl (13) is fixed at an inner, lower side of the covering member (11).

3. The tape of claim 1, wherein the vinyl (14) is fixed at an outer, lower side of the covering member (11).

4. The tape of claim 1, wherein in a state where the vinyl (13) fixed at the covering member (11) remains stretched out, a surface which is exposed to the outside is corona-processed.

5. The tape of claim 2, wherein in a state where the vinyl (13) fixed at the covering member (11) remains stretched out, a surface which is exposed to the outside is corona-processed.

6. The tape of claim 3, wherein in a state where the vinyl (13) fixed at the covering member (11) remains stretched out, a surface which is exposed to the outside is corona-processed.
